(19) United States
(12) Patent Application Publication
(10) Pub. No.: US 2024/0217820 A1
(43) Pub. Date: Jul. 4, 2024

(54) HIGH ENERGY RECOVERY PROCESS FOR THE PRODUCTION OF NITRIC ACID

(71) Applicant: Atlas Agro Holding AG, Zug (CH)

(72) Inventors: Petter ØSTBØ, Baar (CH); Ottar Bernt SKJERVE, Bærum (NO)

(21) Appl. No.: 18/150,093

(22) Filed: Jan. 4, 2023

(51) Int. Cl. C01B 21/26; C25B 1/04

(52) U.S. Cl. CPC C01B 21/262; C01B 21/265; C25B 1/04

(57) ABSTRACT

A high energy recovery process in nitric acid production process recovers, utilizes and/or stores heat energy in at least four stages. In the first stage, a first heat energy is recovered at the catalytic oxidation of ammonia to nitric oxide to generate high-pressure steam used for a first electrical power generation. A second heat energy is recovered at the catalytic oxidation of nitric oxide to nitrogen dioxide to generate low-pressure steam used for a second electrical power generation in the second stage. The nitrogen dioxide is further cooled in a condenser and a third heat energy is recovered and stored in a thermal storage via a heat pump. The nitrogen gas is absorbed to produce nitric acid in an absorber resulting in a hot tail gas stream. The hot tail gas stream is expanded over a tail gas turbine for a third electrical power generation.

### TECHNICAL FIELD

The present invention primarily relates to a process for the preparation of nitric acid.

### BACKGROUND ART

Nitric acid, which is known by various names such as aqua fortis, the spirit of niter, azotic acid, nitryl hydroxide, and hydrogen nitrate, is one of the most important commodities used in the chemical industry. It is used in the production of fertilizers, plastics, paints, fabrics, dyes, lacquers, and explosives.

Industrially, nitric acid is produced by the catalytic oxidation of ammonia with excess air. In the first step, ammonia gets oxidized to form nitrogen oxide (NO), which is then further oxidized to form nitrogen dioxide (NO₂) or dinitrogen tetroxide (N₂O₄). Nitrogen dioxide is later reacted with water in an absorption column to result in nitric acid. This process of production of nitric acid is also called as the Ostwald process.

All nitrogen oxides (NO, NO₂, N₂O₄, and N₂O) together are referred to as NOₓ. The non-reacted NOₓ tail gas formed is required to be purified and vented into the atmosphere.

There are two basic types of nitric acid production processes—(a) Mono-pressure processes operating at a single pressure throughout the stages of catalytic ammonia oxidation and absorption; and (b) Dual-pressure processes operating at low pressures for ammonia oxidation and higher pressures for absorption. Mono-pressure processes operate at either medium pressures (2-6 atm) or higher pressures (7-12 atm). Modern dual-pressure processes operate at 4-6 atm at the oxidation stage and 9-15 atm at the absorption stage.

The production of nitric acid has a long operating history. The process has been subject to extensive research and development to improve energy efficiency, yield, safety performance and emission reductions.

All existing processes have been optimized to be run as a part of a fossil fueled integrated site, or as a standalone nitric acid process unit. However, of late, many renewable forms of energy such as solar and wind are successfully replacing conventional fossil fuel-based electrical energy production methods. The world is increasingly adopting greener methods of energy production.

Accordingly, there remains a need in the art to provide efficient processes and systems for nitric acid production that can be integrated to zero-carbon emission sites that use renewable sources for electrical power generation.

### SUMMARY OF THE INVENTION

An object of the present invention is to provide a high energy recovery process for the production of nitric acid.

Accordingly, the inventors have developed a novel process and system for a highly efficient production of nitric acid wherein heat energy is recovered/utilized/stored in at least four stages.

In accordance with a first aspect of the present disclosure, an energy efficient process for the production of nitric acid is provided. The process comprises the steps of:
(a) mixing compressed air, ammonia, and gaseous oxygen to obtain a gaseous mixture;
(b) catalytically oxidizing the ammonia in a first reactor to obtain an ammonia oxidized stream comprising nitric oxide;
(c) catalytically oxidizing the ammonia oxidized stream comprising nitric oxide in a second reactor to obtain a nitric oxide oxidized stream comprising nitrogen dioxide;
(d) cooling the nitric oxide oxidized stream comprising nitrogen dioxide to obtain a cooled gaseous stream;
(e) absorbing the cooled gaseous stream in water to obtain nitric acid and a tail gas; wherein energy is recovered from the steps (b), (c), and (d).

In an embodiment of the present invention, the catalytic oxidation of ammonia to nitric oxide is performed over a platinum catalyst. In another embodiment, the catalytic oxidation of nitric oxide to nitrogen dioxide is performed over a platinum catalyst.

A high-pressure heat recovery and steam generation section is utilized to recover a first heat energy from step (b) and generate a high-pressure supercritical steam at 220-250 bar a at 550-600° C. The high-pressure supercritical steam is expanded over a high-pressure steam turbine. In an embodiment, the high-pressure steam turbine is operationally coupled to a first generator for a first electrical power generation.

A low-pressure heat recovery and steam generation section is utilized to recover a second heat energy from step (c) and generate a low-pressure steam at 5-10 bar a at 250-300° C. The low-pressure steam is expanded over a low-pressure steam turbine. In an embodiment, the low-pressure steam turbine is operationally coupled with a second generator for a second electrical power generation.

In accordance with an embodiment of the present invention, a third heat energy is recovered from the cooler condenser and transmitted by means of at least one heat pump and stored by means of a thermal storage.

In an embodiment, as a by-product, a tail gas stream comprising nitrogen and residual nitrogen oxides (NOₓ) is produced at the absorber. This tail gas is heated at the tail gas preheater to obtain a hot tail gas at 400-700° C. This hot tail gas is expanded over a tail gas turbine. In an embodiment, the tail gas turbine is operationally coupled with a third generator for a third electrical power generation.

In another embodiment, all of the high-pressure steam turbine, the low-pressure steam turbine, and the tail gas turbine are operationally coupled with a single generator for a single combined electrical power generation.

In another embodiment, the energy recovered from the step (d) is transmitted by means of at least one heat pump and stored by means of a thermal storage.

In certain embodiments, at least one of the electrical power generated from the first electrical power generation, the second electrical power generation, and the third electrical power generation or the combined electrical power generation is supplied to at least one electrolyzer in a water electrolysis process for hydrogen production. In an embodiment, the gaseous oxygen obtained from the water electrolysis process for hydrogen production is sent to step (a) of the process. In another embodiment, the gaseous oxygen obtained from the water electrolysis process for hydrogen production is sent to step (c) of the process.

In accordance with another aspect of the present disclosure, a system for the production of nitric acid is provided. The system comprises:
(a) a first reactor comprising a catalyst configured to accept a mixture of compressed air, ammonia, and gaseous oxygen and perform catalytic oxidation of ammonia to nitric oxide;
(b) a high-pressure heat recovery and steam generation section configured to recover a first heat energy from the first reactor;
(c) a second reactor configured to perform catalytic oxidation of the nitric oxide to nitrogen dioxide;
(d) a low-pressure heat recovery and steam generation section configured to recover a second heat energy from the second reactor;
(e) a cooler condenser configured to cool the nitrogen dioxide to a cooled gaseous stream;
(f) at least one heat pump to transmit a third heat energy from the cooler condenser;
(g) a thermal storage in fluid communication with the at least one heat pump and configured to store the third heat energy; and
(h) an absorber configured to absorb nitrogen dioxide in water to obtain nitric acid and a tail gas.

### BRIEF DESCRIPTION OF THE DRAWINGS

The illustrated embodiments of the subject matter will be best understood by reference to the drawings, wherein like parts are designated by like numerals throughout. The following description is intended only by way of example, and simply illustrates certain selected embodiments of devices, systems, and processes that are consistent with the subject matter as claimed herein.

Embodiments of the present disclosure will now be described, by way of example only, with reference to the following drawings wherein:

FIG. 1 illustrates a schematic block flow diagram of an embodiment of the nitric acid production process according to the present invention.

The following reference numerals are used in the description and FIGURES:

| | |
|---|---|
| 600 - First Reactor | 621 - Low-Pressure Steam Drum |
| 601 - First Mixer | 622 - Low-pressure Steam Superheater |
| 602 - Second Mixer | 624 - Low-Pressure Economizer |
| 610 - High-pressure Steam | 623 - Low-Pressure Steam Boiler |
| Superheater | |
| 611 - High-pressure Steam | 625 - Low-Pressure Boiler Feed |
| Drum | Water Preheater |
| 612 - High-pressure Steam | 650 - Air Compressor |
| Boiler | |
| 613 - Tail gas preheater | 660 - High-Pressure Steam Turbine |
| 614 - High-Pressure Economizer | 661 - Low-Pressure Steam Turbine |
| 615 - Boiler Feed Water | 662 - Low-Pressure Steam Turbine |
| Preheater | Condenser |
| 616 - Cooler Condenser | 690 - Low-Pressure Steam Grid |
| 617 - Compression, Heat | 700 - Tail Gas Turbine |
| Recovery | |
| 618 - Absorber | 930 - Heat Pump |
| 620 - Second Reactor | 980 - Thermal Storage |

Subscripts:
g—gas
l—liquid
aq—aqueous

### DETAILED DESCRIPTION OF THE EMBODIMENTS

The following description is presented to enable any person skilled in the art to make and use the invention as claimed and is provided in the context of the particular examples discussed below, variations of which will be readily apparent to those skilled in the art. In the interest of clarity, not all features of an actual implementation are described in the given specification. It will be appreciated that in the development of any such actual implementation (as in any development project), design decisions must be made to achieve the designers' specific goals (e.g., compliance with system- and business-related constraints), and that these goals will vary from one implementation to another.

Example apparatus are described herein. Other example embodiments or features may further be utilized, and other changes may be made, without departing from the spirit or scope of the subject matter presented herein. In the following detailed description, reference is made to the accompanying drawings, which form a part thereof.

The example embodiments described herein are not meant to be limiting. It will be readily understood that the aspects of the present disclosure, as generally described herein, and illustrated in the drawings, can be arranged, substituted, combined, separated, and designed in a wide variety of different configurations, all of which are explicitly contemplated herein.

The inventors have developed a novel process for a highly efficient production of nitric acid. Particularly, the process as described herein is configured to recover/utilize/store heat energy in at least four stages. The heat energy recovered at different stages can be used to generate electrical power.

A conventional nitric acid production process is either a standalone process or a part of a fossil-fueled integrated site wherein fossil fuels are utilized to produce ammonia. The present invention is meant to be integrated with a green ammonia process where electrical energy from renewables is utilized for the electrolysis of water to produce hydrogen and a subsequent production of ammonia, and where the invention generates electrical power which may be used for further water electrolysis for hydrogen production, thereby, improving the energy efficiency of the integrated hydrogen, ammonia and nitric acid production.

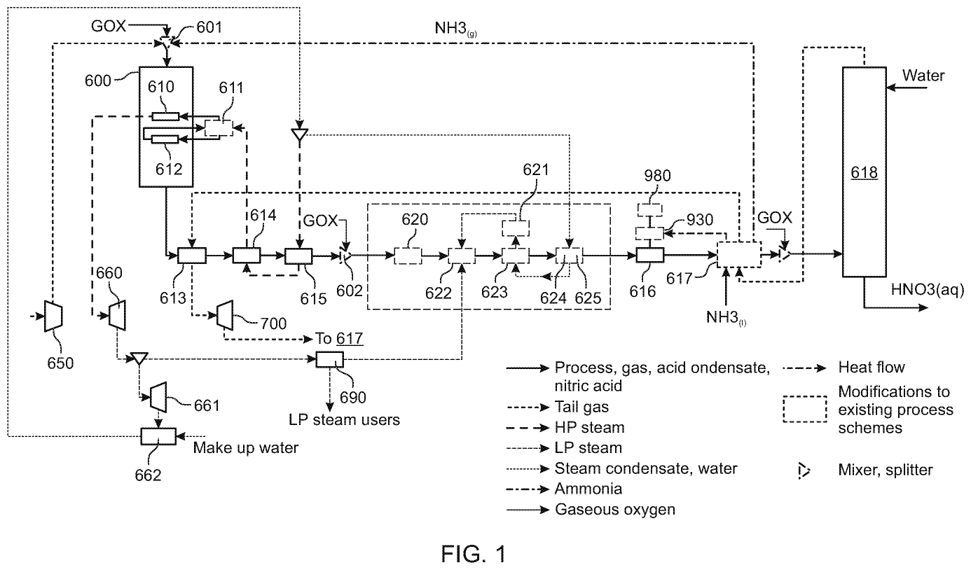

Referring to FIG. 1, there is provided a simplified process description of the nitric acid production process enabled to recover heat energy at various stages, in accordance with the first aspect of the present invention. Compressed air, superheated ammonia, and gaseous oxygen GOX are mixed in a first mixer (601) upstream a first reactor (600) to provide a gaseous mixture. It is customary to provide all the feed streams of the gaseous mixture at a pressure slightly above the pressure of the first reactor (600). In one embodiment, an air compressor (650) is used to generate the compressed air. In another embodiment, the gaseous oxygen GOX is from a water electrolysis reaction for hydrogen production.

In an embodiment, platinum catalyst layers made of woven or knitted gauze are used in the first reactor (600). The gaseous mixture is heated where oxygen and ammonia react on the catalyst layers according to the following reaction (1) to produce an ammonia oxidized stream comprising nitric oxide.

$$4 {NH}_{3} + 5 {O}_{2} \to 4 NO + 6 {H}_{2} O \\ Δ {H}_{R} = - 905 kJ / mol ( temperature 550 - 600 ° C . ) \qquad ( 1 )$$

The oxidation process of ammonia to produce nitric oxide is highly exothermic. A high-pressure heat recovery and steam generation section (HP HRSG) is utilized to recover a first heat energy from the first reactor (600) and generate a high-pressure supercritical steam. In an embodiment, the high-pressure supercritical steam is at a pressure of 220-250 bar a and a temperature of 550-600° C.

In accordance with an embodiment of the invention, the high-pressure heat recovery and steam generation section (HP HRSG) comprises: a high-pressure steam superheater (610), a high-pressure steam boiler (612), a high-pressure steam drum (611), a tail gas preheater (613), a high-pressure economizer (614) and a boiler feed water preheater (615). The ammonia oxidized stream comprising nitric oxide exiting the boiler feed water preheater (615) is at a temperature of 900-1000° C.

In an embodiment, the high-pressure supercritical steam is expanded over a high-pressure steam turbine (660). In an embodiment, the high-pressure steam turbine is operationally coupled with a first generator for a first electrical power generation.

This ammonia oxidized stream comprising nitric oxide is mixed with gaseous oxygen GOX in a second mixer (602) to form a reaction mixture. In an embodiment, a catalyst comprising platinum layers made of woven or knitted gauze are used in the second reactor (620). In another embodiment, the catalyst comprising platinum tablets are used in the second reactor (620). In a further embodiment, the catalyst in the form of woven or knitted gauze or tablets are deposited on a solid carrier material and then used in the second reactor (620). The reaction mixture is heated where oxygen and nitric oxide react on the catalyst according to the following reaction (2) to produce a nitric oxide oxidized stream comprising nitrogen dioxide. In an embodiment, the gaseous oxygen GOX sent to the second mixer (602) is the gaseous oxygen GOX obtained from the water electrolysis process for hydrogen production.

$$2 NO + {O}_{2} \to {NO}_{2} \\ Δ {H}_{R} = - 114 kJ / mol ambient temperature \qquad ( 2 )$$

The oxidation process of nitric oxide to produce nitrogen dioxide is also exothermic. A low-pressure heat recovery and steam generation section is utilized to recover a second heat energy from the second reactor and generate a first low-pressure steam. In an embodiment, the first low-pressure steam is at a pressure of 5-10 bar a and a temperature of 250-300° C.

In accordance with an embodiment of the invention, the low-pressure heat recovery and steam generation section (LP HRSG) comprises a low-pressure steam drum (621), a low-pressure steam superheater (622), a low-pressure steam boiler (623), a low-pressure economizer (624), and a low-pressure boiler feed water preheater (625). The nitric oxide oxidized stream comprising nitrogen dioxide exiting the low-pressure boiler feed preheater (625) is at a temperature of 150-180° C.

In an embodiment, the low-pressure steam is expanded over a low-pressure steam turbine (661). In an embodiment, the low-pressure steam turbine (661) is operationally coupled with a second generator for a second electrical power generation.

The nitric oxide oxidized stream comprising nitrogen dioxide is further cooled, for example, to ambient temperature, in a cooler condenser (616) to obtain a cooled gaseous stream comprising nitrogen dioxide. A third heat energy is recovered by means of the cooler condenser (616). The third heat energy is transmitted by means of at least one heat pump (930) and stored by means of a thermal storage (980).

Gas from the cooler condenser (616) is sent to a compression (dual pressure process only) and heat recovery section (617) to optimize the energy efficiency of the process. At least one heat pump (930) is used to recover low grade heat from the compression and heat recovery section (617). In an embodiment entailing a mono-pressure process, the cooled gaseous stream comprising nitrogen dioxide is sent directly to an absorber (618). Heat from the process is recovered by vaporizing liquid ammonia that is sent to mixer (601) where it is mixed with air from the air compressor 650. Any excess heat maybe recovered by heat pump (980) and stored in the thermal storage 990.

The cooled gaseous stream (mono-pressure process) or compressed cooled gaseous stream (dual-pressure process) comprising nitrogen dioxide is directed to the absorber (618) wherein nitrogen dioxide is subjected to a process of absorption to form nitric acid. The absorption of nitrogen dioxide into water is according to the following reaction (3).

$$3 {NO}_{2} + {H}_{2} {O}_{( I )} \to 2 {HNO}_{3 ( aq )} + NO \\ Δ {H}_{R} = - 117 kJ / mol ambient temperature \qquad ( 3 )$$

A tail gas comprising unreacted nitric oxide and nitrogen dioxide from the absorber (618) is directed to the tail gas preheater (613). The tail gas preheater (613) heats the tail gas to obtain a hot tail gas at a temperature of about 400-700° C. The hot tail gas is expanded over a tail gas turbine (700). In an embodiment, the tail gas turbine is operationally coupled with a third generator for a third electrical power generation.

In another embodiment, all of the high-pressure steam turbine, the low-pressure steam turbine and the tail gas turbine are operationally coupled with a single generator for a single combined electrical power generation.

In accordance with an embodiment of the invention, a second low-pressure steam is extracted downstream the high-pressure steam turbine (660). In an embodiment, both of the first low-pressure steam and the second low-pressure steam are sent to a low-pressure steam grid (690). The low-pressure steam grid (690) balances the low-pressure steam supply demand wherever needed. In case of surplus steam in the low-pressure steam grid (690), the excess steam is sent from the grid (690) to the low-pressure steam turbine (661).

A third low-pressure steam is extracted downstream the low-pressure steam turbine (661) and directed to a steam turbine condenser (662) to obtain a condensate. The condensate can be recycled back to the high-pressure heat recovery and steam generation and low-pressure heat recovery and steam generation sections.

Electrical power from at least one of the first electrical power generation, the second electrical power generation, the third electrical power generation, and the single combined electrical power generation is utilized for supply to at least one electrolyzer for hydrogen generation, or to a battery in front of the at least one electrolyzer regulating the electrical power supply. The electrolysis reaction generates gaseous oxygen as by-product, which is advantageously utilized for oxidation reactions at the first reactor (600) and the second reactor (620), thereby improving the efficiency of the oxidation reactions.

In accordance with another aspect of the present invention, a system for an energy efficient preparation of nitric acid is provided. The system comprises:
(a) a first reactor comprising a catalyst configured to accept a mixture of compressed air, ammonia, and gaseous oxygen and perform catalytic oxidation of ammonia to nitric oxide;
(b) a high-pressure heat recovery and steam generation section configured to recover a first heat energy from the first reactor;
(c) a second reactor configured to perform catalytic oxidation of the nitric oxide to nitrogen dioxide;
(d) a low-pressure heat recovery and steam generation section configured to recover a second heat energy from the second reactor;
(e) a cooler condenser configured to cool the nitrogen dioxide to a cooled gaseous stream;
(f) at least one heat pump to transmit a third heat energy from the cooler condenser;
(g) a thermal storage in fluid communication with the at least one heat pump and configured to store the third heat energy; and
(h) an absorber configured to absorb nitrogen dioxide in water to obtain nitric acid and a tail gas.

The high-pressure heat recovery and steam generation section is configured to generate high-pressure supercritical steam. A high-pressure steam turbine is in fluid communication with the high-pressure heat recovery and steam generation section and is configured to expand the high-pressure supercritical steam. The high-pressure steam turbine is operationally coupled to a first generator for a first electrical power generation.

The low-pressure heat recovery and steam generation section is configured to generate low-pressure steam. A low-pressure steam turbine is in fluid communication with the low-pressure heat recovery and steam generation section and is configured to expand the low-pressure steam. The low-pressure steam turbine is operationally coupled to a second generator for a second electrical power generation.

A heater is configured to heat the tail gas to obtain a hot tail gas. A tail gas turbine is in fluid communication with the heater and is configured to expand the hot tail gas. The tail gas turbine is operationally coupled to a third generator for a third electrical power generation.

In another embodiment, all of the high-pressure steam turbine, the low-pressure steam turbine and the tail gas turbine are operationally coupled with a single generator for a single combined electrical power generation.

It is to be understood that not necessarily all objectives or advantages may be achieved in accordance with any particular embodiment described herein. Thus, for example, those skilled in the art will appreciate that certain embodiments may be configured to operate in a manner that achieves or optimizes one advantage or group of advantages as taught herein without necessarily achieving other objects or advantages as may be taught or suggested herein.

Many other variations other than those described herein will be apparent from this disclosure. For example, depending on the embodiment, certain actions, events, or functions of any of the algorithms described herein may be performed in different sequences, and may be added, merged, or excluded altogether (e.g., not all described actions or events are required to execute the algorithm). Moreover, in certain embodiments, operations or events are performed in parallel, for example, through multithreading, interrupt handling, or through multiple processors or processor cores, or on other parallel architectures, rather than sequentially. In addition, different tasks or processes can be performed by different machines and/or computing systems that can work together.

Unless otherwise stated, conditional languages such as “can,” “could,” “will,” “might,” or “may” are understood within the context as used in general to convey that certain embodiments include, while other embodiments do not include, certain features, elements, and/or steps. Thus, such conditional languages are not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment.

Alternate implementations are included within the scope of the embodiments described herein in which elements or functions may be deleted, executed out of order from that shown, or discussed, including substantially concurrently or in reverse order, depending on the functionality involved as would be understood by those skilled in the art.

Unless otherwise explicitly stated, articles such as “a” or “an” should generally be interpreted to include one or more described items. Accordingly, phrases such as “a device configured to” are intended to include one or more recited devices. Such one or more recited devices can also be collectively configured to carry out the stated recitations.

It will be understood by those within the art that, in general, terms used herein, are generally intended as “open” terms (e.g., the term “including” should be interpreted as “including but not limited to,” the term “having” should be interpreted as “having at least,” the term “includes” should be interpreted as “includes but is not limited to,” etc.).

For expository purposes, the term “horizontal” as used herein is defined as a plane parallel to the plane or surface of the floor of the area in which the system being described is used or the method being described is performed, regardless of its orientation. The term “floor” can be interchanged with the term “ground” or “water surface”. The term “vertical” refers to a direction perpendicular to the horizontal as just defined. Terms such as “above,” “below,” “bottom,” “top,” “side,” “higher,” “lower,” “upper,” “over,” and “under” are defined with respect to the horizontal plane.

As used herein, the terms “engaged,” “connected,” “coupled,” and other such relational terms should be construed, unless otherwise noted, to include removable, moveable, fixed, adjustable, and/or releasable connections or attachments. The connections/attachments can include direct connections and/or connections having intermediate structure between the two components discussed.

Numbers preceded by a term such as “approximately,” “about,” and “substantially” as used herein include the recited numbers, and also represent an amount close to the stated amount that still performs a desired function or achieves a desired result. For example, the terms “approximately,” “about,” and “substantially” may refer to an amount that is within less than 10% of the stated amount. Features of embodiments disclosed herein preceded by a term such as “approximately,” “about,” and “substantially” as used herein represent the feature with some variability that still performs a desired function or achieves a desired result for that feature.

It should be emphasized that many variations and modifications may be made to the above-described embodiments, the elements of which are to be understood as being among other acceptable examples. All such modifications and variations are intended to be included herein within the scope of this disclosure and protected by the following claims.

What is claimed is:

1. A process for producing nitric acid, the process comprising:
(a) mixing compressed air, ammonia, and gaseous oxygen to obtain a gaseous mixture;
(b) catalytically oxidizing the ammonia in a first reactor to obtain an ammonia oxidized stream comprising nitric oxide;
(c) catalytically oxidizing the ammonia oxidized stream comprising nitric oxide in a second reactor to obtain a nitric oxide oxidized stream comprising nitrogen dioxide;
(d) cooling the nitric oxide oxidized stream comprising nitrogen dioxide to obtain a cooled gaseous stream; and
(e) absorbing the cooled gaseous stream in water to obtain nitric acid and a tail gas;
wherein energy is recovered from said (b), (c), and (d).

2. The process as claimed in claim 1, wherein the catalytic oxidization in said (b) is performed over a platinum catalyst.

3. The process as claimed in claim 1, wherein the catalytic oxidization in said (c) is performed over a platinum catalyst.

4. The process as claimed in claim 1, wherein a high-pressure supercritical steam is generated from the energy recovered from said (b).

5. The process as claimed in claim 4, wherein the high-pressure supercritical steam is at a pressure of 220-250 bar a and a temperature of 550-600° C.

6. The process as claimed in claim 1, wherein a low-pressure steam is generated from the energy recovered from said (c).

7. The process as claimed in claim 6, wherein the low-pressure steam is at a pressure of 5-10 bar a and a temperature of 250-300° C.

8. The process as claimed in claim 1, wherein at least a part of the energy from said (b) is used to heat the tail gas to obtain a hot tail gas at a temperature of 400-700° C.

9. The process as claimed in claim 4, wherein the high-pressure supercritical steam is expanded over a high-pressure steam turbine.

10. The process as claimed in claim 6, wherein the low-pressure steam is expanded over a low-pressure steam turbine.

11. The process as claimed in claim 8, wherein the hot tail gas is expanded over a tail gas turbine.

12. The process as claimed in claim 1, wherein the energy recovered from the said (d) is transmitted by means of at least one heat pump and stored by means of a thermal storage.

13. The process of claim 1, wherein the high-pressure steam turbine is operationally coupled to a first generator for a first electrical power generation.

14. The process of claim 10, wherein the low-pressure steam turbine is operationally coupled to a second generator for a second electrical power generation.

15. The process of claim 11, wherein the tail gas turbine is operationally coupled to a third generator for a third electrical power generation.

16. The process of claim 1, wherein:
a high-pressure supercritical steam is generated from the energy recovered from said (b), and the high-pressure supercritical steam is expanded over a high-pressure steam turbine;
a low-pressure steam is generated from the energy recovered from said (c), and the low-pressure steam is expanded over a low-pressure steam turbine;
at least a part of the energy from said (b) is used to heat the tail gas to obtain a hot tail gas at a temperature of 400-700° C., and the hot tail gas is expanded over a tail gas turbine; and
the high-pressure steam turbine, the low-pressure steam turbine, and the tail gas turbine are operationally coupled to a single generator for a single combined electrical power generation.

17. The process as claimed in claim 1, wherein:
a high-pressure supercritical steam is generated from the energy recovered from said (b), and the high-pressure supercritical steam is expanded over a high-pressure steam turbine to generate a first electrical power generation;
a low-pressure steam is generated from the energy recovered from said (c), and the low-pressure steam is expanded over a low-pressure steam turbine to generate a second electrical power generation; or
at least a part of the energy from said (b) is used to heat the tail gas to obtain a hot tail gas at a temperature of 400-700° C., and the hot tail gas is expanded over a tail gas turbine to generate a third electrical power generation; and
wherein at least one of the electrical powers generated from the first electrical power generation, the second electrical power generation, or the third electrical power generation is supplied to at least one electrolyzer in a water hydrolysis process for hydrogen production.

18. The process as claimed in claim 1, wherein the gaseous oxygen is obtained from a water hydrolysis process for hydrogen production.

19. A system for the preparation of nitric acid, wherein the system comprises:
(a) a first reactor comprising a catalyst configured to accept a mixture of compressed air, ammonia, and gaseous oxygen and perform catalytic oxidation of ammonia to nitric oxide;
(b) a high-pressure heat recovery and steam generation section configured to recover a first heat energy from the first reactor;
(c) a second reactor configured to perform catalytic oxidation of the nitric oxide to nitrogen dioxide;
(d) a low-pressure heat recovery and steam generation section configured to recover a second heat energy from the second reactor;
(e) a cooler condenser configured to cool the nitrogen dioxide to a cooled gaseous stream;
(f) at least one heat pump to transmit a third heat energy from the cooler condenser;
(g) a thermal storage in fluid communication with the at least one heat pump and configured to store the third heat energy; and
(h) an absorber configured to absorb nitrogen dioxide in water to obtain nitric acid and a tail gas.

20. The system as claimed in claim 19, wherein the high-pressure heat recovery and steam generation section is configured to generate high-pressure supercritical steam.

21. The system as claimed in claim 19, wherein the low-pressure heat recovery and steam generation section is configured to generate low-pressure steam.

22. The system as claimed in claim 20, wherein a high-pressure steam turbine is in fluid communication with the high-pressure heat recovery and steam generation section and is configured to expand the high-pressure supercritical steam.

23. The system as claimed in claim 21, wherein a low-pressure steam turbine is in fluid communication with the low-pressure heat recovery and steam generation section and is configured to expand the low-pressure steam.

24. The system as claimed in claim 22, wherein the high-pressure steam turbine is operationally coupled to a first generator for a first electrical power generation.

25. The system as claimed in claim 23, wherein the low-pressure steam turbine is operationally coupled to a second generator for a second electrical power generation.

26. The system as claimed in claim 19, wherein a heater is configured to heat the tail gas to obtain a hot tail gas.

27. The system as claimed in claim 26, wherein a tail gas turbine is in fluid communication with the heater and is configured to expand the hot tail gas.

28. The system as claimed in claim 27, wherein the tail gas turbine is operationally coupled to a third generator for a third electrical power generation.

29. The system as claimed in claim 19, wherein
the high-pressure heat recovery and steam generation section is configured to generate high-pressure supercritical steam, and a high-pressure steam turbine is in fluid communication with the high-pressure heat recovery and steam generation section and is configured to expand the high-pressure supercritical steam;
the low-pressure heat recovery and steam generation section is configured to generate low-pressure steam, and a low-pressure steam turbine is in fluid communication with the low-pressure heat recovery and steam generation section and is configured to expand the low-pressure steam;
a heater is configured to heat the tail gas to obtain a hot tail gas, and a tail gas turbine is in fluid communication with the heater and is configured to expand the hot tail gas; and
the high-pressure steam turbine, the low-pressure steam turbine, and the tail gas turbine are operationally coupled to a single generator for a single combined electrical power generation.

30. The process as claimed in claim 16, wherein the electrical power generated from the single combined electrical power generation is supplied to at least one electrolyzer in a water hydrolysis process for hydrogen production.
